(19) United States
(12) Patent Application Publication
(10) Pub. No.: US 2026/0016064 A1
(43) Pub. Date: Jan. 15, 2026

(54) COMBINED AXLE DISCONNECT AND PARK LOCK SYSTEM

(71) Applicant: EATON INTELLIGENT POWER LIMITED, DUBLIN 4 (IE)

(72) Inventors: Nikhil S. MAHAJAN, Maharashtra (IN); Vipin N. RANE, Maharashtra (IN); Pritam S. BHURKE, Maharashtra (IN)

(21) Appl. No.: 18/995,544

(22) PCT Filed: Jul. 18, 2023
(86) PCT No.: PCT/EP2023/025335

§ 371 Date: Jan. 16, 2025

(30) Foreign Application Priority Data
Jul. 19, 2022 (IN) 202211041330

(51) Int. Cl. F16D 67/02; B60K 17/02; B60K 23/08; F16D 67/06; F16H 63/34

(52) U.S. Cl. CPC F16D 67/02; B60K 17/02; B60K 23/08; F16D 67/06; F16H 63/3441; F16H 63/3466; F16H 63/3475

(57) ABSTRACT

A combined axle disconnect and park lock system for a vehicle having a motive source and wheels. The system includes an output shaft and an intermediate gear permanently fixed for rotation with the output shaft. An output gear is mounted for selective relative rotation on the first output shaft. The system further includes a sleeve and a shift assembly configured to move the sleeve relative to the output shaft to place the system in a plurality of conditions. When the system is in a first condition of the plurality of conditions, the sleeve is moved such that the output gear can rotate relative to the first output shaft, and the drive wheels are free to rotate and are not coupled to the motive source. When the system is in a second condition of the plurality of conditions, the sleeve is moved such that the output gear cannot rotate relative to the first output shaft, and the drive wheels are free to rotate and are coupled to the motive source, when the system is in a third condition of the plurality of conditions, the sleeve is moved such that the drive wheels are not free to rotate.

### CROSS-REFERENCE TO RELATED APPLICATIONS

This application claims the benefit of Indian Provisional Patent Application 202211041330, filed Jul. 19, 2022, the disclosure of which is incorporated by reference herein in its entirety.

### FIELD OF INVENTION

The present disclosure relates to a vehicle drivetrain. More particularly the present disclosure relates to a combined axle disconnect and park lock system that combines the functions of axle disconnect and park lock into a single system.

### BACKGROUND

It is becoming common to provide a vehicle with an all-wheel drive system to provide improved traction as compared to front-wheel drive or rear-wheel drive vehicles in low traction scenarios (e.g., inclement weather such as snow).

While an all-wheel drive system can provide comparatively improved traction, it can also reduce the fuel efficiency of a vehicle. To minimize the impact an all-wheel drive system has on fuel efficiency, it is known to provide a vehicle with a disconnect system. The disconnect system disconnects one of the axles from the vehicle's a motive source (e.g., internal combustion engine, electric motor, hybrid arrangement) when the improved traction afforded by the all-wheel drive system is not needed. It is also known to provide a vehicle with a park lock system that prevents movement of the vehicle when not in use.

Traditionally, the disconnect system and the park lock system are provided as separate units and utilize separate actuators. This arrangement, however, can add undesired weight and complexity to the vehicle.

### SUMMARY OF THE INVENTION

In one embodiment a system for providing an axle disconnect and a park lock in a vehicle includes a motor and a shaft. A gear is mounted on the shaft. A bearing is provided between the shaft and the gear. Splines are provided on the gear. A ball screw mechanism is connected to the motor and configured to convert rotary motion of the motor to axial motion along a shift rail. A fork is mounted on the shift rail. The system further includes lock plate splines and a sleeve on the shaft between the lock plate and the gear. The sleeve has parking lock splines and disconnect splines. The fork is configured to move the sleeve toward the splines on the gear or toward the lock plate splines, based on a direction of rotation of the motor.

In another embodiment a combined axle disconnect and park lock system for a vehicle having a motive source and wheels. The system includes an output shaft and an intermediate gear permanently fixed for rotation with the output shaft. An output gear is mounted for selective relative rotation on the first output shaft. The system further includes a sleeve and a shift assembly configured to move the sleeve relative to the output shaft to place the system in a plurality of conditions. When the system is in a first condition of the plurality of conditions, the sleeve is moved such that the output gear can rotate relative to the first output shaft, and the drive wheels are free to rotate and are not coupled to the motive source. When the system is in a second condition of the plurality of conditions, the sleeve is moved such that the output gear cannot rotate relative to the first output shaft, and the drive wheels are free to rotate and are coupled to the motive source. when the system is in a third condition of the plurality of conditions, the sleeve is moved such that the drive wheels are not free to rotate.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a schematic drawing of an exemplary all-wheel drive system,

FIG. 2 is a side view of a combined axle disconnect and park lock system according to one embodiment,

FIG. 3A is a sectional side view of part of the combined axle disconnect and park lock system of FIG. 1,

FIG. 3B is a sectional perspective view of the components shown in FIG. 3A,

FIGS. 4A, 4B, and 4C show part of the combined axle disconnect and park lock system of FIG. 2 when the system is in various conditions,

FIGS. 5A, 5B, and 5C is another view showing part of the combined axle disconnect and park lock system of FIG. 2 including a shift assembly and biasing arrangement when the system is in various conditions,

FIG. 6 is a perspective viewing showing the combined axle disconnect and park lock system installed in a vehicle, and

FIG. 7 is a side view of part of an alternative embodiment of a combined axle disconnect and park lock system.

### DETAILED DESCRIPTION

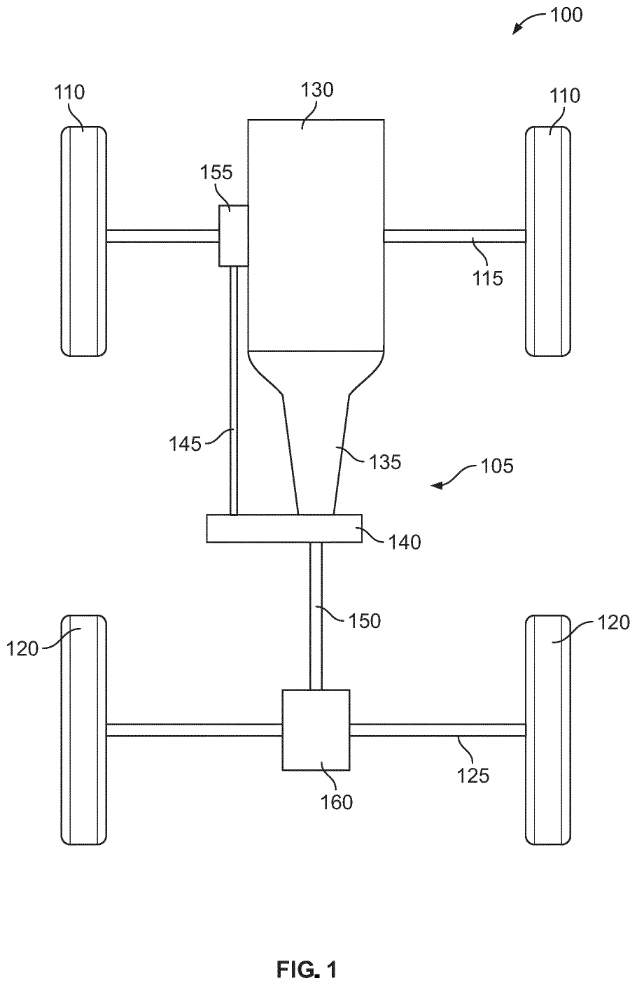

FIG. 1 is a schematic drawing illustrating a vehicle 100 equipped with an exemplary all-wheel drive system 105. The vehicle 100 includes front wheels 110 mounted on a front axle 115, rear wheels 120 mounted on a rear axle 125, and a motive source 130 (e.g., internal combustion engine, electric motor, hybrid arrangement). The motive 130 source outputs power to a transmission 135, which in turn outputs the power to a transfer case 140. The transfer case 140 distributes the power to a front drive shaft 145 and a rear drive shaft 150. The front drive shaft 145 is connected to a front differential 155 provided on the front axle 115 and the rear drive shaft 150 is connected to a rear differential provided 160 on the rear axle 125. The front differential 155 and the rear differential 160 drive the front and rear wheels 110, 120, respectively.

As discussed above, it may be desirable to disconnect the front axle or the rear axle from the motive source in order to improve the vehicle's fuel efficiency when the all-wheel drive system is not needed. In order to achieve this, in addition to other functions, the front or the rear axle may be provided with a combined axle disconnect and park lock system.

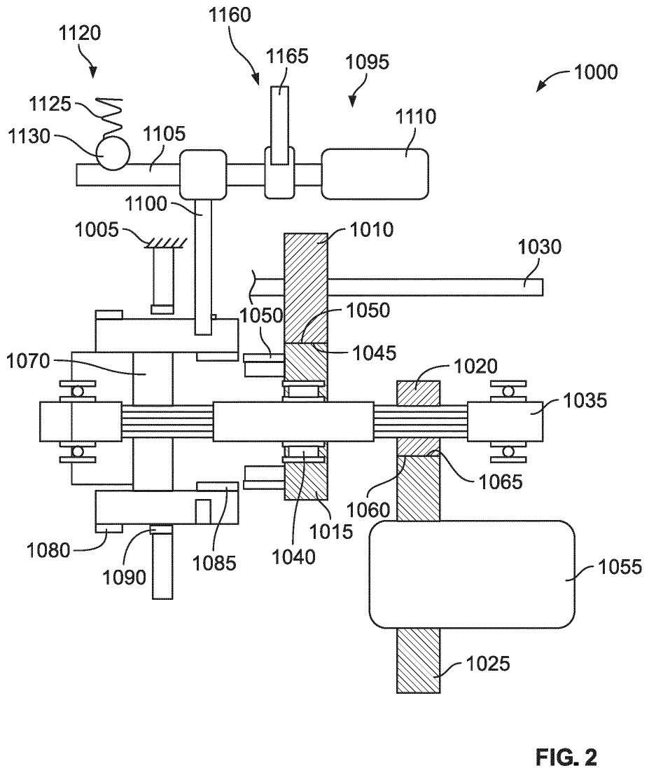

A first embodiment of a combined axle disconnect and park lock system 1000 is shown in FIGS. 2, 3A, 3B, 4A-4C, and 5A-5C. The combined axle disconnect and park lock system 1000 includes a case 1005. The case 1005 houses an input gear 1010, a first output gear 1015, an intermediate gear 1020, and a second output gear 1025. The input gear 1010 is mounted on and permanently fixed for rotation with an input shaft 1030. Thus, the input gear 1010 and the input shaft 1030 cannot rotate relative to one another. The input shaft 1030 may be connected to the front drive shaft 145 or the rear drive shaft 150. For the purposes of this disclosure, the input shaft 1030 is described as being connected to the rear drive shaft 150.

The first output gear 1015 and the intermediate gear 1020 are mounted on a first output shaft 1035. The first output gear 1015 is mounted for selective relative rotation on the first output shaft 1035. Thus, the first output gear 1015 may selectively rotate relative to the first output shaft 1035. A bearing arrangement 1040 may support the first output gear 1015 on the first output shaft 1035 to facilitate rotation therebetween. According to one example embodiment, the bearing arrangement 1040 is provided as a needle roller bearing assembly. In alternative embodiments, any desired bearing arrangement may be used.

The first output gear 1015 includes second teeth 1045 and first splines 1050. The second teeth 1045 of the first output gear 1015 are in constant mesh with first teeth 1050 of the input gear 1010. The intermediate gear 1020 is permanently fixed for rotation with the first output shaft 1035. Thus, the intermediate gear 1020 and the input shaft 1035 cannot rotate relative to one another.

The second output gear 1025 is permanently fixed for rotation with a differential 1055. Thus, the second output gear 1025 and the differential 1055 cannot rotate relative to one another. The second output gear 1025 includes fourth teeth 1060 that are in constant mesh with third teeth 1065 of the intermediate gear 1020. The differential 1055 is connected to the rear wheels 120 of the vehicle 100.

A sleeve 1070 is mounted on the first output shaft 1035. The sleeve 1070 is permanently fixed for rotation with the first output shaft 1035 but slidably mounted thereon. Thus, the sleeve 1070 and the first output shaft 1035 cannot rotate relative to one another, but the sleeve 1070 can translate relative to the first output shaft 1035 along a central longitudinal axis 1075 of the first output shaft 1035. The sleeve 1070 includes parking lock splines 1080 and disconnect splines 1085. The parking lock splines 1080 are selectively engageable with lock plate splines 1090 that are provided in the case 1005. The lock plate splines 1090 are grounded to a stationary object (e.g., lock plate). The disconnect splines 1085 are selectively engageable with the first splines 1050 of the first output gear 1015.

The case 1005 further houses a shift assembly 1095. The shift assembly 1095 is configured to axially move the sleeve 1070 relative to the first output shaft 1035 along the central longitudinal axis 1075 of the first output shaft 1035. The shift assembly 1095 includes a fork 1100 mounted on a shift rail 1105. The fork 1100 is connected to the sleeve 1070. The shift rail 1105 is connected to a linear actuator 1110. According to one example embodiment, the linear actuator 1100 includes a ball screw mechanism and a motor. The ball screw mechanism is connected to the motor and configured to convert rotary motion of the motor to axial motion along the shift rail 1105. The shift rail 1105 may move in opposite directions based on a direction of rotation of the motor. In alternative embodiments, any desired linear actuator may be used (e.g., pneumatic).

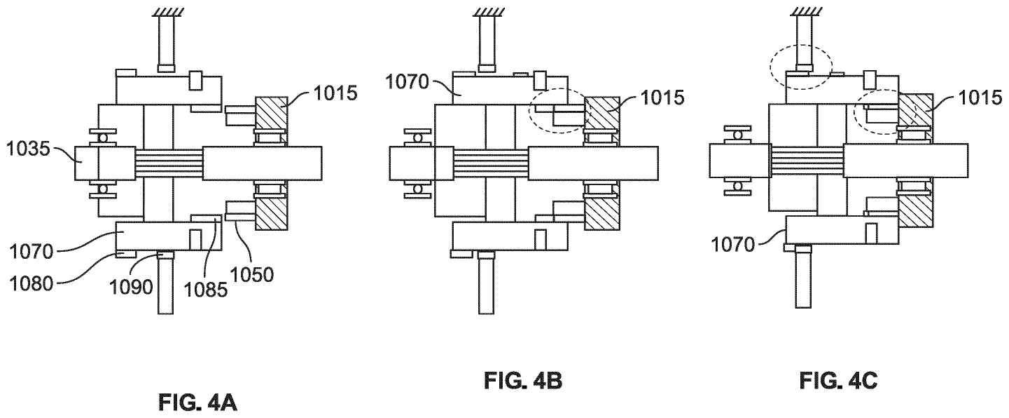

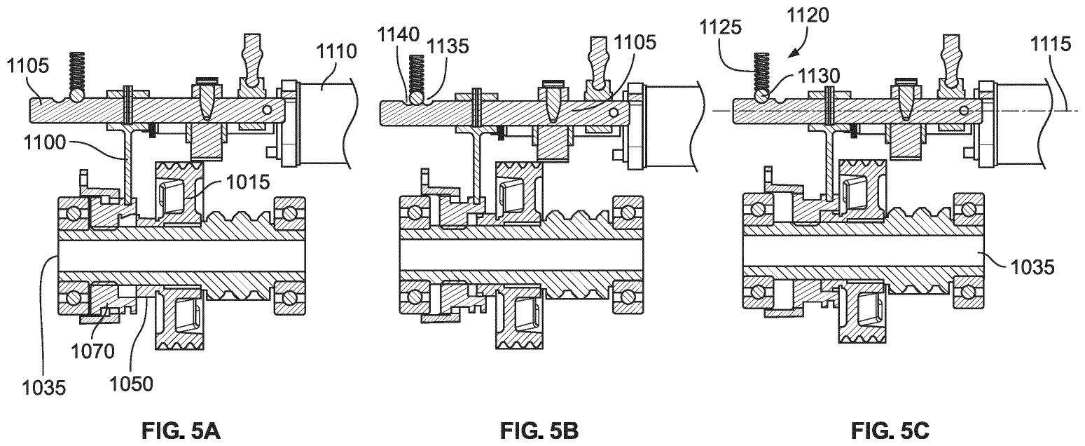

Referring to FIGS. 4A-4C and 5A-5C, the operation of the combined axle disconnect and park lock system 1000 will now be described. The linear actuator 1110 causes the shift rail 1105 to translate along its axis 1115, thereby causing the fork 1100 and the sleeve 1070 to similarly translate. The sleeve 1070 can be moved to place the combined axle disconnect and park lock system 1000 in three different conditions.

The first condition is shown in FIGS. 4A and 5A. In this condition, the linear actuator 1110 is operated to move the sleeve 1070 so that the parking lock splines 1080 are not engaged with the lock plate splines 1090 and the disconnect splines 1085 are not engaged with the first splines 1050 of the first output gear 1015. Thus, although the input shaft 1030 may receive power from the motive source 130 via the rear drive shaft 150, when the system is in the first condition, the first output gear 1015 rotates relative to the first output shaft 1035 and the rear wheels 120 therefore do not receive power (i.e., are not coupled to the motive source 130) but remain free to rotate. The vehicle 100 is thus in two-wheel drive mode.

The second condition is shown in FIGS. 4B and 5B. In this condition, the linear actuator 1110 is operated to move the sleeve 1070 so that the parking lock splines 1080 are still not engaged with the lock plate splines 1090 but, unlike the first condition, the disconnect splines 1085 are engaged with the first splines 1050 of the first output gear 1015. When viewed from the perspective shown in FIGS. 4B and 5B, the sleeve 1070 is moved to the right compared to the position of the sleeve 1070 as shown in FIGS. 4A and 5A. The engagement between the disconnect splines 1085 and the first splines 1050 of the first output gear 1015 effectively fixes the first output gear 1015 for rotation with the first output shaft 1035.

In the second condition, the rear wheels 120 are still free to rotate and now receive power from the motive source 130 (i.e., the rear wheels 120 are coupled to the motive source 130). In particular, power is transferred from the motive source 130 to the input shaft 1030 via the rear drive shaft 1035. This power then moves through the input gear 1010 and the first output gear 1015. The power is then transferred to the sleeve 1070 due to the engagement of the disconnect splines 1085 and the first splines 1050 of the output gear 1015. The power is transferred from the sleeve 1070 through the first output shaft 1035 and to the intermediate gear 1020, then to the second output gear 1025, and is then distributed by the differential 1055 to the rear wheels 120. The vehicle 100 is thus in all-wheel drive mode.

The third condition is shown in FIGS. 4C and 5C. In this condition, the linear actuator 1110 is operated to move the sleeve 1070 so that the parking lock splines 1080 are now engaged with the lock plate splines 1090 and the disconnect splines 1085 are moved further into engagement with the first splines 1050 of the first output gear 1015. When viewed from the perspective shown in FIGS. 4C and 5C, the sleeve 1070 is moved to the right compared to the position of the sleeve 1070 as shown in FIGS. 4B and 5B.

In the third condition, the rear wheels 120 are no longer free to rotate. In particular, the sleeve 1070 cannot rotate due to the engagement between the parking lock splines 1080 and the lock plate splines 1090. Because the sleeve 1070 is fixed for rotation with the first output shaft 1035, the first output shaft 1035 also cannot rotate, thereby preventing rotation of the intermediate gear 1020, the second output gear 1025, the differential 1055 and thus the rear wheels 120. Although the rear wheels 120 are still technically coupled to the motive source 130, the vehicle 100 is not free to move and is effectively parked.

Thus, the combined axle disconnect and park lock system 1000 allows the vehicle 100 to operate in three different modes. When the system 1000 is in the first condition, the vehicle 100 is in a first mode that corresponds to the vehicle 100 being driven as a two-wheel drive vehicle. The first mode may be utilized during normal driving conditions when it is unnecessary to drive all four wheels of the vehicle and may improve the vehicle's fuel efficiency. When the system 1000 is in the second condition, the vehicle 100 is in a second mode that corresponds to the vehicle 100 being driven as an all-wheel drive vehicle. The second mode may be utilized during inclement driving conditions when it is desired to have the extra traction afforded by all-wheel drive. When the system 1000 is in the third condition, the vehicle 100 is in a third mode that corresponds to the vehicle 100 being in a parked mode.

The combined axle disconnect and park lock system 1000 may be provided with a biasing arrangement 1120 that facilitates the system being in one or more of the conditions. As shown in FIGS. 5A-5C, the biasing arrangement 1120 includes a spring 1125 that biases a ball 1130 into a first detent 1135 or a second detent 1140. The first and second detents 1135, 1140 are provided on the shift rail 1105 of the shift assembly 1095. The first detent 1135 is located at a first position on the shift rail 1105 that corresponds to when the system 1000 is in the first condition. The second detent 1140 is located at a second position on the shift rail 1105 that corresponds to when the system 1000 is in the third condition.

When the system 1000 is placed in the first condition and the linear actuator 1110 is operated to move the sleeve 1070 so that the parking lock splines 1080 are not engaged with the lock plate splines 1090 and the disconnect splines 1085 are not engaged with the first splines 1050 of the first output gear 1015, the spring 1125 biases the ball 1130 into the first detent 1135, as shown in FIG. 5A. When the system 1000 is placed in the third condition and the linear actuator 1110 is operated to move the sleeve 1070 so that the parking lock splines 1080 are engaged with the lock plate splines 1090 and the disconnect splines 1085 are engaged with the first splines 1050 of the first output gear 1015, the spring 1125 biases the ball 1130 into the second detent 1140, as shown in FIG. 5C. The ball 1130 is located between the first and second detents 1135, 1140 when the system 1000 is placed in the second condition and the linear actuator 1110 is operated to move the sleeve 1070 so that the parking lock splines 1080 are not engaged with the lock plate splines 1090 and the disconnect splines 1085 are engaged with the first splines 1050 of the first output gear 1015, as shown in FIG. 5B.

The biasing arrangement 1120 may ensure that the sleeve 1070 does not move out of position once a desired condition is selected. Specifically, the engagement between the ball 1130 and one of the first and second detents 1135, 1140 will tend to hold the shift rail 1105 stationary, thereby preventing movement of the fork 1110 and thus the sleeve 1070. Furthermore, the biasing arrangement 1120 may improve accuracy of the shifts. Specifically, locating the first and second detents 1135, 1140 at locations on the shift rail 1105 that correspond to the first and third conditions, respectively, will tend to cause the shift rail 1105 to move to a predetermined position once the ball 1130 is biased into one of the detents 1135, 1140. Additionally, the biasing arrangement 1120 may prevent double engagement. In alternative embodiments, the shift rail may be provided with additional detents. For example, the shift rail may be provided with a third detent that is located between the first and second detents and is positioned at a location on the shift rail that corresponds to when the system is in the second condition.

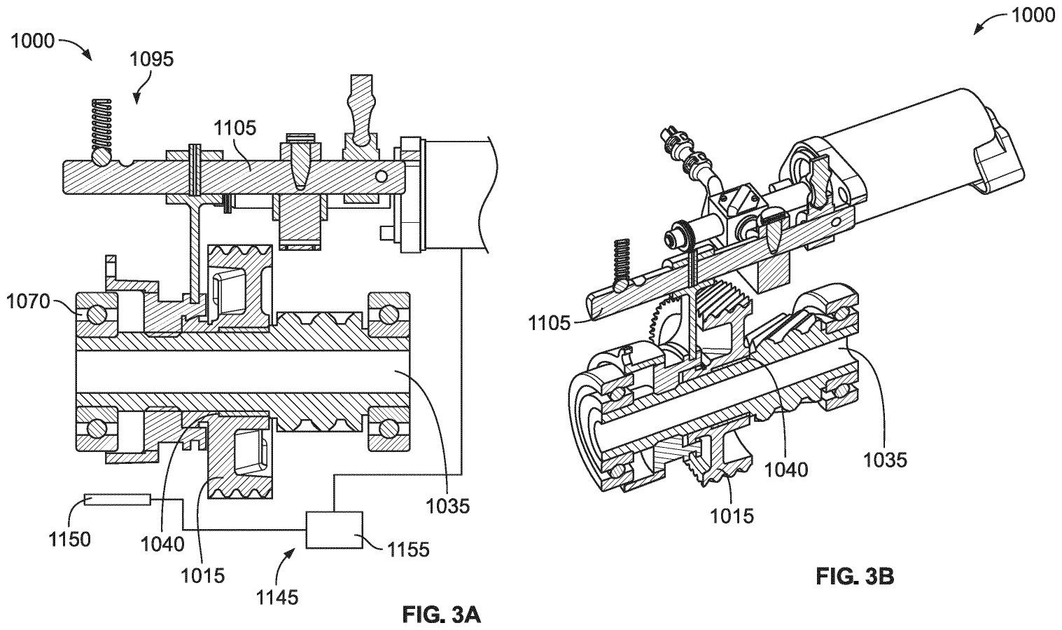

Accuracy of the shifts may be further improved by a sensing arrangement 1145, as shown in FIG. 3A. In the illustrated embodiment, the sensing arrangement 1145 includes a sensor 1150 that is arranged to detect a position of the sleeve 1070. The sensor relays a signal to an ECU 1155, which communicates with the motor of the linear actuator 1110. Based on the information provided by the sensor 1150, the ECU 1155 controls the motor to assist in moving the sleeve 1070 to a desired position. Thus, the sensing arrangement 1145 communicates with the shift assembly 1095 to determine the position of the sleeve 1070.

The system 1000 may be provided with a failsafe 1160 arrangement that is configured to allow the system 1000 to be placed in a desired condition in the event that there is an issue with the shift assembly 1095. In the illustrated embodiment, the failsafe arrangement 1160 includes a lever 1165 connected to the shift rail 1105. The lever 1165 may be easily accessible by an operator of the vehicle 100 and allow the operator to move the shift rail 1105 along its axis. Thus, if an issue with the shift assembly 1095 arises (e.g., the linear actuator 1110 fails), it is still possible to operate the system 1000 and place it in one of the three conditions.

The above described system 1000 thus combines a disconnect system and a park lock system into a single unit. The single unit utilizes a single actuator to provide two different functions, specifically axle disconnect and park lock. Compared to known arrangements that provide the axle disconnect and park lock function with two separate systems and thus two separate actuators, the cost of the combined axle disconnect and park lock system 1000 is lower. Additionally, by eliminating an actuator, the system 1000 is more compact and may have improved reliability. Moreover, the specific arrangement described herein increases the probability of the park lock engagement occurring, and may result in a smoother, less jerky engagement during park lock actuation. Additionally, the system 1000 may reduce the time it takes for park lock engagement to occur.

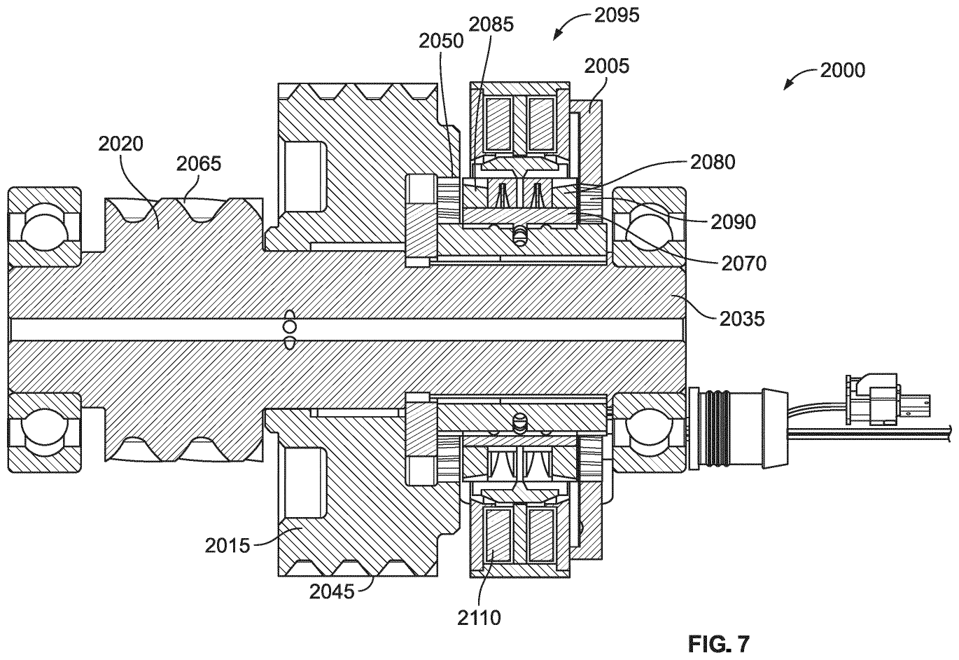

FIG. 7 shows an alternative embodiment of a combined axle disconnect and park lock system 2000. The combined axle disconnect and park lock system 2000 of FIG. 7 is substantially the same as the system of FIGS. 2-5 except for the differences described herein. Accordingly, like features will be identified by like numerals increased by a factor of “1000.” In particular, FIG. 7 shows an alternate embodiment for the sleeve and shift assembly and the discussion of FIG. 7 will be limited accordingly.

A first output gear 2015 and an intermediate gear 2020 are mounted on a first output shaft 2035 in a case 2005. The first output gear 2015 is mounted for selective relative rotation on the first output shaft 2035. The first output gear 2015 includes second teeth 2045 and first splines 2050. The second teeth 2045 of the first output gear 2015 are in constant mesh with first teeth of a first input gear (not shown) that is mounted on and permanently fixed for rotation with an input shaft (not shown). The intermediate gear 2020 is permanently fixed for rotation with the first output shaft 2035. The intermediate gear 2020 includes third teeth 2065 that are in constant mesh with fourth teeth of a second gear (not shown) that is fixedly connected to a differential (not shown).

A sleeve 2070 is mounted on the first output shaft 2035. The sleeve 2070 is permanently fixed for rotation with the first output shaft 2065 but slidably mounted thereon. The sleeve 2070 includes parking lock splines 2080 and disconnect splines 2085. The parking lock splines 2080 are selectively engageable with lock plate splines 2090 that are provided in the case 2005. The disconnect splines 2085 are selectively engageable with the first splines 2050 of the first output gear 2015.

The case 2005 further houses a shift assembly 2095. The shift assembly 2095 is configured to axially move the sleeve 2070 relative to the first output shaft 2035. The shift assembly 2095 includes an electromagnetic actuator 2110 that is positioned adjacent to sleeve 2070. As used herein, “adjacent” means that that the electromagnetic actuator 2110 is positioned close enough to the sleeve 2070 to effect movement thereof.

Operation of the combined axle disconnect and park lock system 2000 of FIG. 7 is similar to the operation of the system of FIGS. 2-5. The electromagnetic actuator 2110 causes the sleeve 2070 to move relative to the first output shaft 2035, which places the axle disconnect and park lock system 2000 in one of three conditions. In the first condition, the electromagnetic actuator 2110 moves the sleeve 2070 so that the parking lock splines 2080 are not engaged with the lock plate splines 2090 and the disconnect splines 2085 are not engaged with the first splines 2050 of the first output gear 2015. As discussed above, this allows the vehicle to be driven as a two-wheel drive vehicle. The system 2000 is shown in the first condition in FIG. 7.

In the second condition, the electromagnetic actuator 2110 moves the sleeve 2070 to the left (i.e., toward the intermediate gear 2020) compared to the position the sleeve 2070 assumes in the first condition, causing the disconnect splines 2085 to engage with the first splines 2050 of the first output gear 2015. The parking lock splines 2080 are not engaged with the lock plate splines 2090. As discussed above, this allows the vehicle to be driven as an all-wheel drive vehicle.

In the third condition, the electromagnetic actuator 2110 moves the sleeve 2070 to the right (i.e., away from the intermediate gear 2020) compared to the position the sleeve 2070 assumes in the first condition, causing the parking lock splines 2080 to engage with the lock plate splines 2090. The disconnect splines 2085 are not engaged with the first splines 2050 of the first output gear 2050. This causes the vehicle to be in a park mode.

Compared with the arrangement of the system of FIGS. 2-5 the system of FIG. 7 may provide a more compact and simpler assembly. Additionally, the system of 7 may be cheaper and faster to manufacture. In alternative embodiments, the components of the system of FIG. 7 may be configured so that, similar to the system of FIGS. 2-5, the disconnect splines are engaged with the first splines and the parking lock splines are engaged with the lock plate splines in the third condition.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

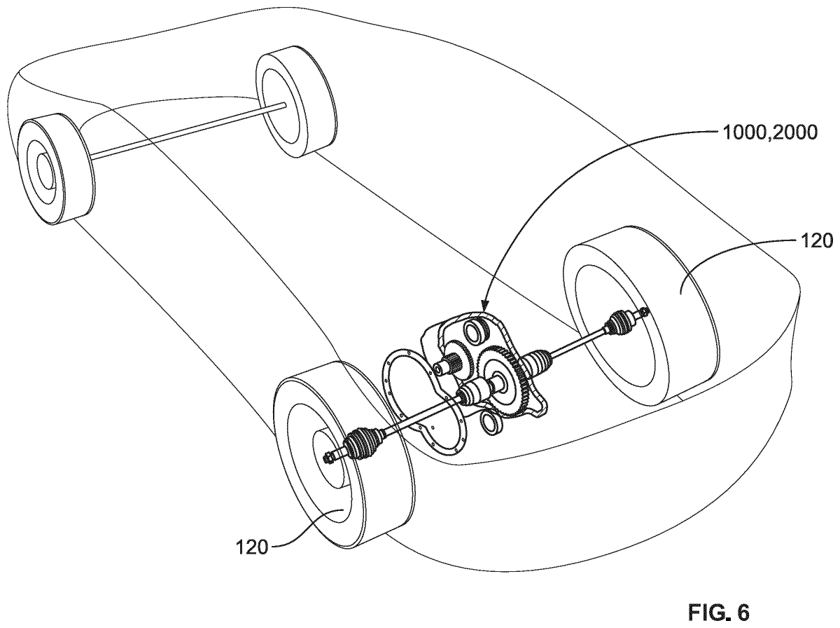

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. For example, the biasing arrangement or the sensing arrangement described with reference to the system of FIGS. 2-5 may be adapted for use with the system of FIG. 7. As another example, although the input shaft of the combined axle disconnect and park lock system has been described as receiving power from a front drive shaft or a rear drive shaft, the combined axle disconnect and park lock system may be integrated into an axle and receive power directly from an electric motor. Such an arrangement is shown in FIG. 6. Accordingly, departures may be made from such details without departing from the spirit or scope of the applicant's general inventive concept.

What is claimed is:

1. A system for providing an axle disconnect and a park lock in a vehicle, comprising:
a motor;
a shaft;
a gear mounted on the shaft;
a bearing between the shaft and the gear;
splines on the gear;
a ball screw mechanism connected to the motor and configured to convert rotary motion of the motor to axial motion along a shift rail;
a fork mounted on the shift rail;
lock plate splines; and
a sleeve on the shaft between the lock plate and the gear, the sleeve having parking lock splines and disconnect splines;
wherein the fork is configured to move the sleeve such that the parking lock splines are engaged with the lock plate splines while the disconnect splines are engaged with the splines on the gear.

2. The system of claim 1, further comprising a biasing arrangement including a ball and a plurality of detents on the shift rail, the detents having positions that correspond to:
a first condition where wheels of the vehicle are not coupled to a motive source and the wheels are free to rotate; and
a second condition where the wheels of the vehicle are coupled to the motive source and the wheels are not free to rotate.

3. The system of claim 2, wherein, when the system is in the first condition, the sleeve is positioned so that the parking lock splines are not engaged with the lock plate splines and the disconnect splines are not engaged with the splines on the gear, and the ball is located in a first detent of the plurality of detents.

4. The system of claim 3, wherein, when the system is in the second condition, the sleeve is positioned so that the parking lock splines are engaged with the lock plate splines and the disconnect splines are engaged with the splines on the gear, and the ball is located in a second detent of the plurality of detents.

5. The system of claim 4, wherein, when the system is in a third condition, the sleeve is positioned so that the parking lock splines are not engaged with the lock plate splines and the disconnect splines are engaged with the splines on the gear, and the ball is located between the first detent and the second detent.

6. A combined axle disconnect and park lock system for a vehicle having a motive source and wheels, the system comprising:
an output shaft;
an intermediate gear permanently fixed for rotation with the output shaft;
an output gear mounted for selective relative rotation on the first output shaft, the output gear having first splines;
a sleeve mounted on the output shaft, the sleeve having parking lock splines and disconnect splines;
a shift assembly configured to move the sleeve relative to the output shaft to place the system in a plurality of conditions; and
lock plate splines;
wherein, when the system is in a first condition of the plurality of conditions, the sleeve is moved such that the output gear can rotate relative to the first output shaft, and the drive wheels are free to rotate and are not coupled to the motive source;
wherein, when the system is in a second condition of the plurality of conditions, the sleeve is moved such that the output gear cannot rotate relative to the first output shaft, and the drive wheels are free to rotate and are coupled to the motive source; and
wherein, when the system is in a third condition of the plurality of conditions, the sleeve is moved such that the drive wheels are not free to rotate, the parking lock splines being engaged with the lock plate splines while the disconnect splines are engaged with the first splines when the system is in the third condition.

7. The combined axle disconnect and park lock system of claim 6 further comprising a biasing arrangement configured to bias the system into the first condition or the third condition.

8. The combined axle disconnect and park lock system of claim 7, wherein the shift assembly includes a shift rail attached to the sleeve and a linear actuator for moving the shift rail.

9. The combined axle disconnect and park lock system of claim 8, wherein the biasing arrangement includes a ball, a first detent, and a second detent, the first detent and the second detent being provided on the shift rail.

10. The combined axle disconnect and park lock system of claim 9, wherein the ball is located in the first detent when the system is in the first condition, wherein the ball is located in the second detent when the system is in the third condition, and wherein the ball is located between the first detent and the second detent when the system is in the second condition.

11. The combined axle disconnect and park lock system of claim 6, wherein when the system is in the second condition or the third condition, the sleeve is moved such that disconnect splines are engaged with the first splines.

12. (canceled)

13. The combined axle disconnect and park lock system of claim 6, wherein the shift assembly includes an electromagnetic actuator that is positioned adjacent to the sleeve.

14. The combined axle disconnect and park lock system of claim 6, wherein when the system is in the second condition the sleeve is moved such that the disconnect splines are engaged with the first splines and the parking lock splines are disengaged from the lock plate splines.

15. The combined axle disconnect and park lock system of claim 7 further comprising a sensing arrangement that is configured to communicate with the shift assembly to determine the position of the sleeve.

16. A method of disconnecting an axle and engaging a park locking in a vehicle comprising the steps of:
providing a system comprising:
a motor;
a shaft;
a gear mounted on the shaft;
a bearing between the shaft and the gear;
splines on the gear;
a ball screw mechanism connected to the motor and configured to convert rotary motion of the motor to axial motion along a shift rail;
a fork mounted on the shift rail;
lock plate splines; and
a sleeve on the shaft between the lock plate and the gear, the sleeve having parking lock splines and disconnect splines; and
moving the fork to cause the sleeve to move such that the parking lock splines are engaged with the lock plate splines while the disconnect splines are engaged with the splines on the gear.

17. The method of claim 16, wherein the step of moving the fork includes rotating the motor.

18. The method of claim 16, wherein the step of providing a system further includes providing a biasing arrangement that includes a ball and a plurality of detents on the shift rail.

19. The method of claim 18, wherein the step of moving the fork includes causing the sleeve to move so that the ball is located in a first detent of the plurality of detents, the first detent corresponding to a first condition wherein wheels of the vehicle are not coupled to a motive source and the wheels are free to rotate.

20. The method of claim 19, wherein the step of moving the fork includes causing the sleeve to move so that the ball is located in a second detent of the plurality of detents, the second detent corresponding to a second condition wherein the wheels of the vehicle are coupled to the motive source and the wheels are not free to rotate.
